(19) United States
(12) Patent Application Publication
(10) Pub. No.: US 2008/0211313 A1
(43) Pub. Date: Sep. 4, 2008

(54) SERIES REGULATOR

(76) Inventor: Yuuichi NAKAMURA, Kashihara-shi (JP)

Correspondence Address: BIRCH STEWART KOLASCH & BIRCH, PO BOX 747, FALLS CHURCH, VA, 22040-0747, US

(21) Appl. No.: 12/029,950

(22) Filed: Feb. 12, 2008

(30) Foreign Application Priority Data
Feb. 13, 2007 (JP) 2007-032089

(51) Int. Cl. H02J 1/00; G05F 1/44

(52) U.S. Cl. 307/75; 323/265; 323/282

(57) ABSTRACT

A series regulator, which includes a power adjusting portion to which power is supplied, the power adjusting portion making an adjustment to the power thus supplied and outputting the power thus adjusted to a load, and an adjustment control portion detecting an output voltage that is a voltage outputted to the load and controlling the adjustment based on the detection result, is provided with: a current detecting portion for detecting an output current that is a current outputted to the load; and a power supplying section for supplying the power to the power adjusting portion after changing a voltage according to the detection result of the current detecting portion. With this configuration, even when the magnitude of the output current varies, it is possible to appropriately adjust the input voltage according to the variations in the output current.

This nonprovisional application claims priority under 35 U.S.C. §119(a) on Patent Application No. 2007-032089 filed in Japan on Feb. 13, 2007, the entire contents of which are hereby incorporated by reference.

### BACKGROUND OF THE INVENTION

1. Field of the Invention

The present invention relates to series regulators that adjust power and output the power thus adjusted to a load.

2. Description of Related Art

Conventionally, a series regulator has been widely adopted as one of the stabilized power supplies. With reference to FIG. 8, an example of the configuration of a conventional series regulator will be described.

This series regulator adjusts an output voltage to a reference value that has previously been set according to the requirements of a load by controlling a base current of a current-adjusting power transistor 113 with a control IC 120, thereby producing a stable direct-current voltage. The control IC 120 makes a comparator 122 compare a reference voltage produced by a built-in or external reference voltage circuit 123 with an adjusted voltage obtained by dividing the output voltage with resistors. Based on a difference between the reference voltage and the adjusted voltage, the control IC 120 adjusts the base current of the power transistor 113 via a control transistor 121, and thereby controls the collector current of the power transistor 113. In this way, the output voltage is stabilized.

The series regulator is generally provided with a protection circuit such as an overcurrent protection circuit 125, an overheating protection circuit 124, or the like. Such a protection circuit protects the series regulator from a breakdown or the like by limiting the base current of the power transistor 113 if an overcurrent occurs or the temperature inside the series regulator increases. In addition, some series regulators are so configured as to turn ON/OFF a power supply to a load connected to an output terminal thereof by controlling ON/OFF of a power supply to a comparator, for example.

Incidentally, power loss Q in the series regulator is, in general, given by formula (1) below.

Q={(input voltage)−(output voltage)}×(output current) (1)

In recent years, as electronic apparatuses have become increasingly sophisticated in functionality and the like, power supply devices such as series regulators have been increasingly required to output a large current.

This tendency results in higher power loss in the series regulator, and hence an increase in heat generation of the regulator itself. As heat generation of the regulator itself increases, problems arises, such as a necessity to provide a heatsink having a large footprint on the substrate of the regulator, or to increase the size of the package of the regulator. To avoid such problems, it is preferable to minimize the difference between the input voltage and the output voltage in the regulator, as shown in formula (1) above, in order to reduce power loss in the series regulator. Incidentally, examples of such series regulators are seen in JP-A-H11-259152 and JP-U-S63-168512.

On the other hand, in the series regulator, the difference between the input voltage and the output voltage of the series regulator itself generally has to increase roughly proportionately with an increase in the output current. As a result, even though the output voltage is kept constant, as the output current varies depending on a load, the needed input voltage varies accordingly (the higher the output current, the larger the needed input voltage).

Therefore, the input voltage of the series regulator is generally set rather high, such that the series regulator can operate normally even if the output current is maximized. However, doing so allows a high input voltage to be always applied even when the output current is not so large, making power loss in the series regulator unnecessary high.

Incidentally, when the difference between the input voltage and the output voltage is large, switching regulators seem to be more effective in terms of power loss. Disadvantageously, however, the switching regulators are produced at higher cost and more vulnerable to noise than the series regulators. Due to those disadvantages of the switching regulators, the series regulators remain a favorable option as before.

### SUMMARY OF THE INVENTION

In view of the conventionally experienced problems described above, an object of the present invention is to provide series regulators that, even when the magnitude of an output current varies, can appropriately adjust an input voltage according to the variations in the output current.

To achieve the above object, according to a first aspect of the present invention, a series regulator, which includes a power adjusting portion to which power is supplied, the power adjusting portion making an adjustment to the power thus supplied and outputting the power thus adjusted to a load, and an adjustment control portion detecting an output voltage that is a voltage outputted to the load and controlling the adjustment based on the detection result, is provided with: a current detecting portion for detecting an output current that is a current outputted to the load; and a power supplying section for supplying the power to the power adjusting portion after changing a voltage according to the detection result of the current detecting portion.

With this configuration, it is possible to change the voltage (input voltage) of power supplied to the power adjusting portion according to the output current. As a result, even when the magnitude of the output current varies, it is possible to appropriately adjust the input voltage according to the variations in the output current.

More specifically, in the series regulator configured as described above, the power adjusting portion may be a transistor connecting between a source of the power and the load with collector and emitter terminals thereof, and the adjustment control portion may control the adjustment by controlling a base current of the transistor based on the result of a comparison of the output voltage and a predetermined reference voltage.

In the series regulator configured as described above, the power supplying section may be provided with: a switch circuit performing switching between a plurality of power supplies that output power at different voltages for selecting any one of the plurality of power supplies, and connecting the selected power supply to the power adjusting portion; and a switching control portion for controlling the switching performed by the switch circuit according to the detection result of the current detecting portion.

With this configuration, it is possible to supply power at different voltages to the power adjusting portion by means of switching performed by the switch circuit. This helps realize the above-described configuration with ease.

In the series regulator configured as described above, the switching control portion may control the switching according to the result of comparison of the detection result of the current detecting portion and a predetermined threshold value.

With this configuration, the threshold value is set depending on at what voltage supplied power can achieve more desired effect. This makes it possible to realize the above-described configuration with ease.

The series regulator configured as described above may be provided with a threshold value setting portion for setting the threshold value in such a way that the threshold value thus set can be changed to any other value.

With this configuration, even when a voltage at which supplied power can achieve more desired effect varies, it is possible to realize appropriate switching control by appropriately setting the threshold value according to the variations in the voltage.

In the series regulator configured as described above, the current detecting portion may detect the output current by detecting the temperature of the transistor.

Since there is a correlation between the output current and the temperature of the transistor (which depends on Joule heat), this configuration makes it possible to detect the output current. Incidentally, conventional series regulators usually have an overheating protection function (with which the temperature is detected). Thus, by using this function, it is possible to eliminate the need for the addition of an extra sensor for detecting the output current.

In the series regulator configured as described above, the current detecting portion may be an overcurrent protection circuit for detecting the output current, and controlling the adjustment in such a way that the detection result is kept below a predetermined value.

Since the conventional series regulators usually have an overcurrent protection circuit, this configuration makes it possible to eliminate the need for the addition of an extra sensor by using the overcurrent protection circuit as a current detecting portion.

More specifically, in the series regulator configured as described above, the switch circuit may include a relay or a semiconductor device, and the power supplying section may be provided with a switching regulator.

In the series regulator configured as described above, the power supplying section may change the voltage linearly according to the detection result of the current detecting portion, and supply the power to the power adjusting portion.

With this configuration, it is possible to supply the power adjusting portion with power at a voltage following variations in the output current with greater accuracy. This makes it possible to minimize power loss in the power adjusting portion regardless of variations in the output current.

The series regulator configured as describe above may be provided with an output terminal for outputting the detection result of the current detecting portion to the outside.

With this configuration, for example, by outputting the detection result to a microcomputer of an electronic apparatus provided with this series regulator, it is possible to make the microcomputer perform various types of processing according to the output current. In addition, it is possible to use the detection result in more complicated current limiting processing performed in a previous stage of the series regulator.

According to a second aspect of the present invention, a series regulator, which includes a power adjusting portion to which power is supplied, the power adjusting portion making an adjustment to the power thus supplied and outputting the power thus adjusted to a load, and an adjustment control portion detecting an output voltage that is a voltage outputted to the load and controlling the adjustment based on the detection result, is provided with: a signal input terminal for receiving, from outside, a signal indicating an output current that is a current outputted to the load; and a power supplying section for supplying power to the power adjusting portion after changing a voltage according to the signal inputted to the signal input terminal.

With this configuration, in a case where, for example, an external device (a current detector) for outputting the detection result of the output current is provided in conjunction with the series regulator, it is possible to change a voltage of the supplied power according to the detection result of the current detector. This makes it possible to obtain the same benefit as that of the configuration of the first aspect while using no current detecting portion.

According to a third aspect of the present invention, an electronic apparatus is provided with the series regulator configured as described above. This makes it possible to enjoy the advantages offered by the configurations described above.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a configuration diagram of a series regulator of Example 1 according to the invention;

FIG. 2 is a configuration diagram of a series regulator of Example 2 according to the invention;

FIG. 3 is a configuration diagram of a series regulator of Example 3 according to the invention;

FIG. 4 is a configuration diagram of a series regulator of Example 4 according to the invention;

FIG. 5 is a configuration diagram of a series regulator of Example 5 according to the invention;

FIG. 6 is a configuration diagram of the switching regulator circuit of Example 5 according to the invention;

FIG. 7 is another configuration diagram of the switching regulator circuit of Example 5 according to the invention; and

FIG. 8 is a configuration diagram showing an example of a conventional series regulator

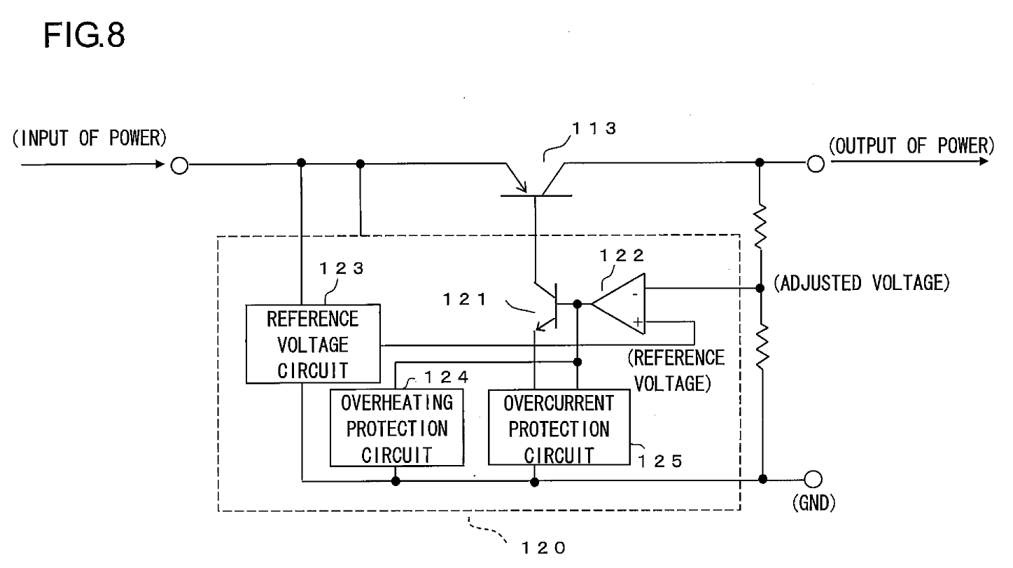

### DETAILED DESCRIPTION OF PREFERRED EMBODIMENTS

Hereinafter, embodiments of the present invention will be described, taking up Examples 1 to 5 as examples.

### EXAMPLE 1

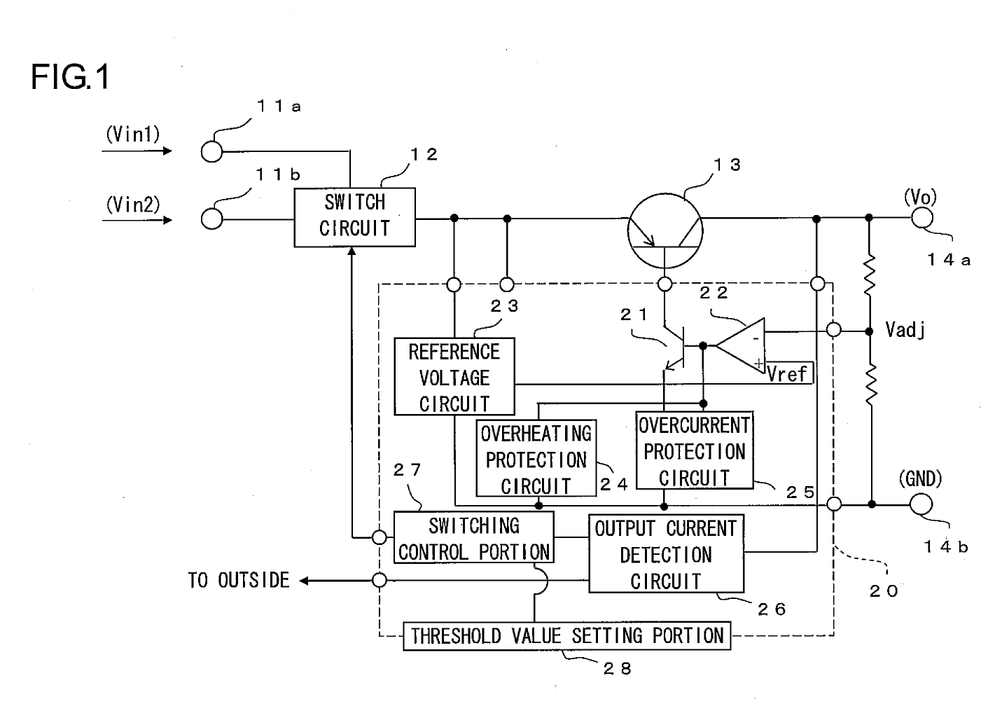

Hereinafter, Example 1 of the invention will be described, taking up as an example a series regulator having a configuration shown in FIG. 1. As shown in this figure, this series regulator includes power input terminals 11a and 11b, a switch circuit 12, a power transistor 13, a power output terminal 14a, a ground terminal 14b, a control IC 20, and the like. With this configuration, the series regulator supplies power to an electrical load, such as an LED, connected between the power output terminal 14a and the ground terminal 14b. The series regulator is incorporated in an electronic apparatus, for example, and serves as a power supply device.

Power at a voltage Vin1 and power at a voltage Vin2 are inputted to the power input terminals 11a and 11b, respectively. Here, Vin1 and Vin2 are different voltages.

The switch circuit 12 is built as a circuit including a relay, a circuit including a semiconductor device such as a transistor, or the like. The switch circuit 12 performs switching between the power input terminals 11a and 11b for selecting any one of them, and connects the selected terminal to the emitter terminal of the power transistor 13. That is, the switch circuit 12 can switch between a state in which the power input terminal 11a and the power transistor 13 are connected together, and a state in which the power input terminal 11b and the power transistor 13 are connected together. As will be described later, this switching is controlled by a switching control portion 27.

The power transistor 13 is built with a PNP transistor. The emitter terminal of the power transistor 13 is connected to the switch circuit 12, the collector terminal thereof is connected to the power output terminal 14a, and the base terminal thereof is connected to the control IC 20. With this configuration, the power inputted from a previous stage (the side of the switch circuit 12) is adjusted by the control IC 20, and is then outputted to a following stage (the side of the power output terminal 14a). Incidentally, the power transistor 13 is not limited to a PNP transistor, but may be of any other type.

The control IC 20 is built as an IC chip provided with a control transistor 21, a comparator 22, a reference voltage circuit 23, an overheating protection circuit 24, an overcurrent protection circuit 25, an output current detection circuit 26, a switching control portion 27, a threshold value setting portion 28, and the like.

The control transistor 21, the comparator 22, and the reference voltage circuit 23 work in cooperation with each other to control the base current of the power transistor 13, and thereby control power supply to the load. More specifically, the comparator 22 is made to compare a voltage Vadj obtained by dividing a voltage (an output voltage) outputted to the load with a plurality of resistors with a predetermined reference voltage Vref produced by the reference voltage circuit 23. Based on the comparison results thus obtained, the control transistor 21 adjusts the base current of the power transistor 13. Through this series of processing, the output voltage is so controlled as to become equal to the reference voltage.

The overheating protection circuit 24 has a temperature sensor placed near the power transistor 13, and monitors the temperature conditions of the power transistor 13. If the temperature detected by the temperature sensor is found to exceed a predetermined threshold value, the overheating protection circuit 24 controls the control transistor 21 in such a way that power to be supplied to the load decreases, or power supply thereto is stopped. This control helps prevent the temperature of the power transistor 13 from becoming excessively high due to Joule heat.

The overcurrent protection circuit 25 monitors the magnitude of the output current outputted to the load. If the magnitude is found to exceed a predetermined threshold value, the overcurrent protection circuit 25 controls the control transistor 21 in such a way that power to be supplied to the load decreases, or power supply thereto is stopped. This control helps prevent an abnormal current from being outputted due to some malfunction, and causing a breakdown or the like of the load or device.

The output current detection circuit 26 continuously detects the magnitude of the output current outputted to the load. The detection result thus obtained is outputted as a detection signal to the outside via a terminal of the control IC 20. With this configuration, for example, by outputting the detection signal to a microcomputer of an electronic apparatus provided with this switching regulator, it is possible to make the microcomputer perform various types of processing according to the output current. In addition, it is also possible to use the detection signal in more complicated current limiting processing performed in a previous stage of the series regulator. The detection information obtained by the output current detection circuit 26 is also transmitted to the switching control portion 27.

The switching control portion 27 compares the detection result (the magnitude of the output current) of the output current detection circuit 26 with a predetermined threshold value, and controls the switching of the switch circuit 12 (performs switching control thereof) based on the comparison result thus obtained. The threshold value setting portion 28 sets the threshold value in such a way that the threshold value thus set can be changed to any other value according to a user's instruction. The threshold value setting portion is built with an external variable resistor, for example. Next, how to perform switching control will be described in detail.

Here, assume that the voltage Vin1 inputted to the terminal 11a is 5 V, the voltage Vin2 inputted to the terminal 11b is 3 V, and the voltage Vo outputted from the terminal 14a is 2.5 V. In addition, assume that the performance of the power transistor 13 requires the difference Vᵢ₋ₒ, between the input voltage and the output voltage to be at least 0.5 V if the output current is 0.5 A, and to be at least 1 V if the output current is 1 A.

In this case, if the output current is 1 A to satisfy the needs of the load, the required difference Vᵢ₋ₒ, is 1 V. As a result, an input voltage of at least 3.5 V (1 V+2.5 V) is needed. On the other hand, if the output current is equal to or smaller than 0.5 A, the difference Vᵢ₋ₒ, simply has to be equal to or lower than 0.5 V. As a result, an input voltage of 3 V (=0.5 V+2.5 V) will suffice.

Therefore, based on the detection information obtained by the output current detection circuit 26, the switching control portion 27 controls the switch circuit 12 in such a way that the power input terminal 11b is connected to the power transistor 13 if the output current is smaller than 0.5 A, and that the power input terminal 11a is connected to the power transistor 13 if the output current is equal to or larger than 0.5 A.

As a result of this control, when the output current is 0.3 A, for example, power loss in this series regulator is of the order of (3V−2.5V)×0.3 A=0.15 W. On the other hand, under the same conditions, power loss in a series regulator whose input voltage is fixed at 5 V is of the order of (5V−2.5V)×0.3 A=0.75 W. As will be understood from the example described above, with the series regulator of Example 1, it is possible to greatly reduce power loss when the output current is relatively small. This helps realize an improvement in efficiency, and reduce heat generation in the regulator itself.

Example 1 described above deals with switching control in which a threshold value to be compared with the magnitude of the output current is set to 0.5 A. However, as described earlier, this threshold value can be changed to any other value by the threshold value setting portion 28. Thus, even when the performance of the power transistor 13, the magnitudes of the voltages Vin1 and Vin2, or the like, are changed, it is possible to perform switching control in a proper manner by appropriately setting the threshold value in response to those changes.

### EXAMPLE 2

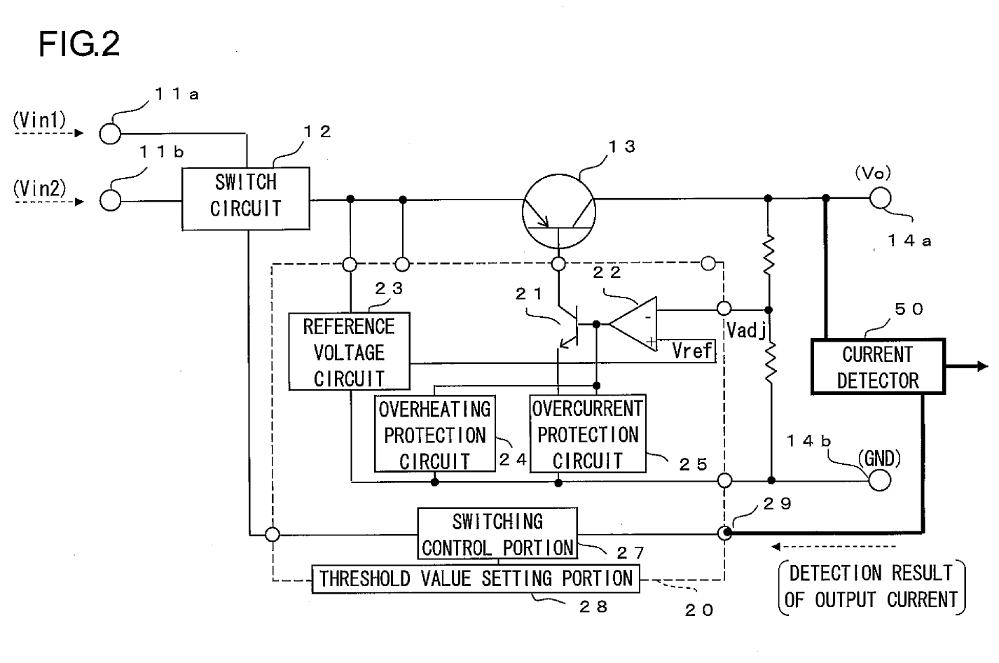

Next, Example 2 of the invention will be described, taking up as an example a series regulator having a configuration shown in FIG. 2. Example 2 differs from Example 1 in that, for example, no output current detection circuit is provided, and a switch circuit is controlled based on an external signal. In other respects, the configuration of Example 2 is basically the same as that of Example 1, and therefore no overlapping description thereof will be repeated.

The switching control portion 27 of Example 2 performs control in the same manner as that of Example 1, but differs therefrom in a path through which it acquires information on the magnitude of the output current. That is, in Example 1, the switching control portion 27 acquires the information from the output current detection circuit 26; in this Example, the switching control portion 27 acquires the information by a signal inputted to a terminal 29 of the control IC 20 from outside. From another point of view, in this Example, as a result of the switching control portion 27 having received a signal inputted from outside, the magnitude of the output current is detected.

With this configuration, as shown in FIG. 2, in a case where a current detector 50 for detecting the output current of this series regulator for some purpose is provided as an external device, by inputting the detection signal of the current detector 50 to the terminal 29, it is possible to make the switching control portion 27 perform control in the same manner as in Example 1.

As a result, it is possible to eliminate the need for a device corresponding to the output current detection circuit 26, and hence further simplify the circuit configuration of the series regulator itself. Incidentally, from the viewpoint of preventing a malfunction from occurring in such cases as when the terminal 29 is in a disconnected state, or no signal is fed to the terminal 29, the switch circuit 12 may be so controlled in such cases that the power input terminal 11b is always connected to the power transistor 13.

### EXAMPLE 3

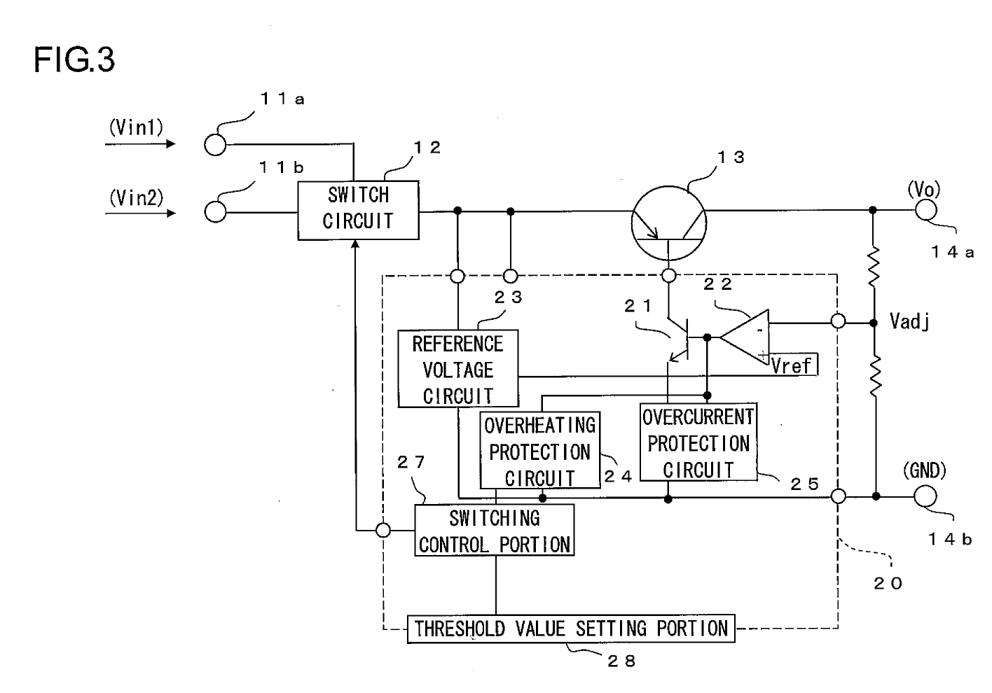

Next, Example 3 of the invention will be described, taking up as an example a series regulator having a configuration shown in FIG. 3. Example 3 differs from Example 1 in that, for example, no output current detection circuit is provided, and a switch circuit is controlled based on an output signal of an overheating protection circuit. In other respects, the configuration of Example 3 is basically the same as that of Example 1, and therefore no overlapping description thereof will be repeated.

The switching control portion 27 of Example 3 performs control in the same manner as that of Example 1, but differs therefrom in a path through which it acquires information on the magnitude of the output current. That is, in Example 1, the switching control portion 27 acquires the information from the output current detection circuit 26; in this Example, the switching control portion 27 acquires the information by a signal inputted from the overheating protection circuit 24.

As is the case with Example 1, the overheating protection circuit 24 of this Example monitors the temperature conditions of the power transistor 13, and controls the control transistor 21 according to the temperature thus detected. In addition, the overheating protection circuit 24 of this Example transmits the temperature information thus obtained to the switching control portion 27. The switching control portion 27 controls the switch circuit 12 according to whether or not the temperature thus obtained is higher than a predetermined threshold value.

The threshold value described above is set in such a way that it can be changed to any other value by the threshold value setting portion 28. For example, by setting as the threshold value a given temperature likely to be detected when the output current is 0.5 A, it is possible to make the switch circuit 12 perform switching according to whether or not the output current is larger than 0.5 A. Incidentally, since the temperature of the power transistor 13 greatly depends Joule heat, it is closely related to the magnitude of the output current. Therefore, it is possible to detect the magnitude of the output current based on the temperature information of the power transistor 13.

According to this Example, it is possible to control the switch circuit 12 based on the detection information obtained by the overheating protection circuit 24. This makes it possible to eliminate the need for a device corresponding to the output current detection circuit 26, and hence further simplify the circuit configuration of the series regulator itself.

### EXAMPLE 4

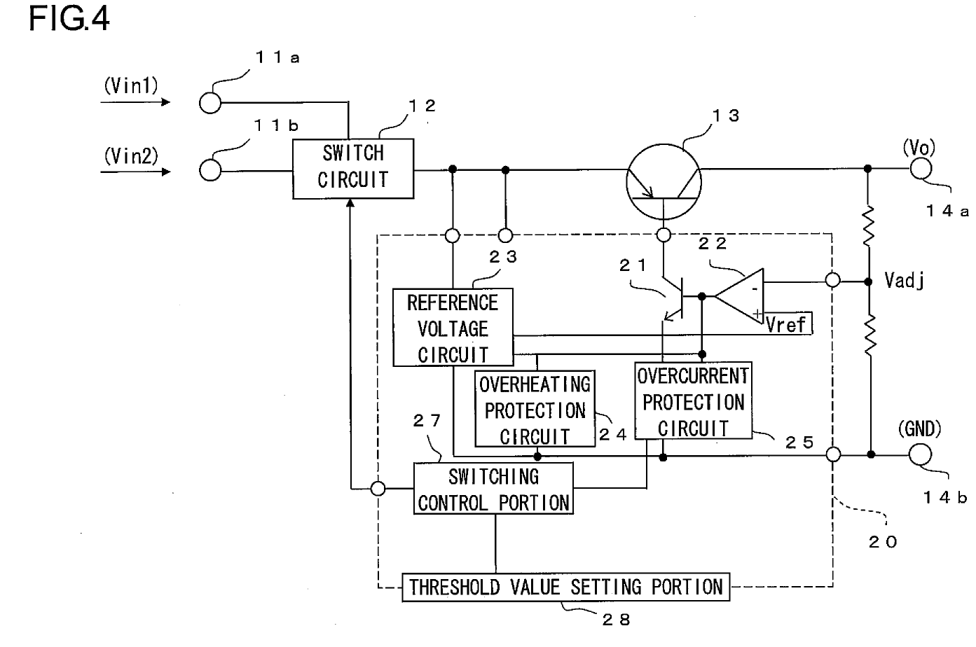

Next, Example 4 of the invention will be described, taking up as an example a series regulator having a configuration shown in FIG. 4. Example 4 differs from Example 1 in that, for example, no output current detection circuit is provided, and a switch circuit is controlled based on an output signal of an overcurrent protection circuit. In other respects, the configuration of Example 4 is basically the same as that of Example 1, and therefore no overlapping description thereof will be repeated.

The switching control portion 27 of Example 4 performs control in the same manner as that of Example 1, but differs therefrom in a path through which it acquires information on the magnitude of the output current. That is, in Example 1, the switching control portion 27 acquires the information from the output current detection circuit 26; in this Example, the switching control portion 27 acquires the information by a signal inputted from the overcurrent protection circuit 25.

As is the case with Example 1, the overcurrent protection circuit 25 of this Example monitors the magnitude of the output current outputted to the load, and controls the control transistor 21 according to the output current thus detected. In addition, the overcurrent protection circuit 25 of this Example transmits the output current information thus obtained to the switching control portion 27. The switching control portion 27 controls the switch circuit 12 based on the information thus obtained.

According to this Example, it is possible to control the switch circuit 12 based on the detection information obtained by the overcurrent protection circuit 25. This makes it possible to eliminate the need for a device corresponding to the output current detection circuit 26, and hence further simplify the circuit configuration of the series regulator itself.

### EXAMPLE 5

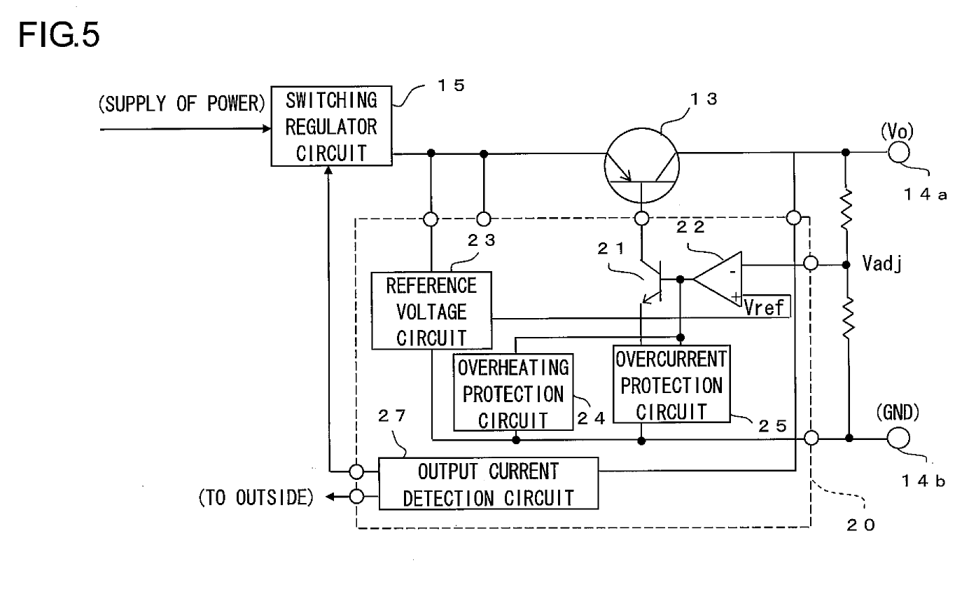

Next, Example 5 of the invention will be described, taking up as an example a series regulator having a configuration shown in FIG. 5. Example 5 differs from Example 1 in that, for example, a switching regulator circuit 15 is used in place of the switch circuit 12, the switching control portion 27, or the like. In other respects, the configuration of Example 5 is basically the same as that of Example 1, and therefore no overlapping description thereof will be repeated.

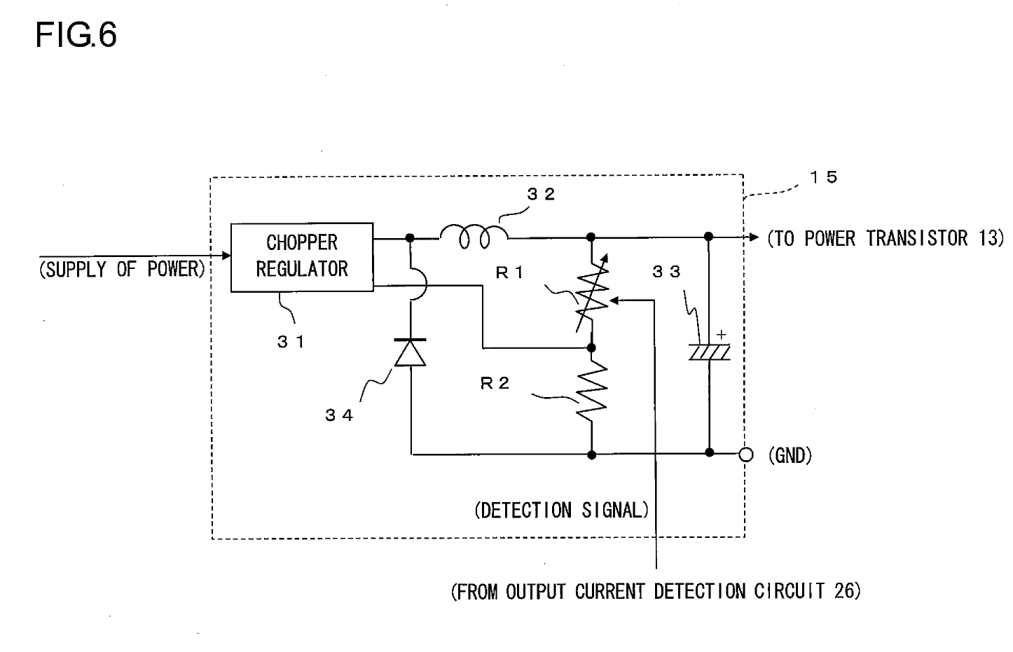

The switching regulator circuit 15 adjusts the supplied power based on a detection signal (information on the magnitude of the output current) received from the output current detection circuit 26, and outputs the adjusted power to the power transistor 13. Here, the configuration of the switching regulator circuit 15 is shown in FIG. 6.

As shown in FIG. 6, the switching regulator circuit 15 includes a chopper regulator 31 receiving power supply from outside, a coil 32, an electrolytic capacitor 33, a diode 34, a variable resistor R1, a resistor R2, and the like. The chopper regulator 31 is connected at the output end thereof to the power transistor 13 via the coil 32. The coil 32 is grounded at the output end thereof via a circuit in which the variable resistor R1 and the resistor R2 are connected in series, and via the electrolytic capacitor 33. The coil 32 is grounded at the input end thereof via the diode 34 (having a cathode at the coil 32 side). A voltage between the variable resistor R1 and the resistor R2 is inputted to the chopper regulator 31. The resistance value of the variable resistor R1 varies according to a detection signal from the output current detection circuit 26.

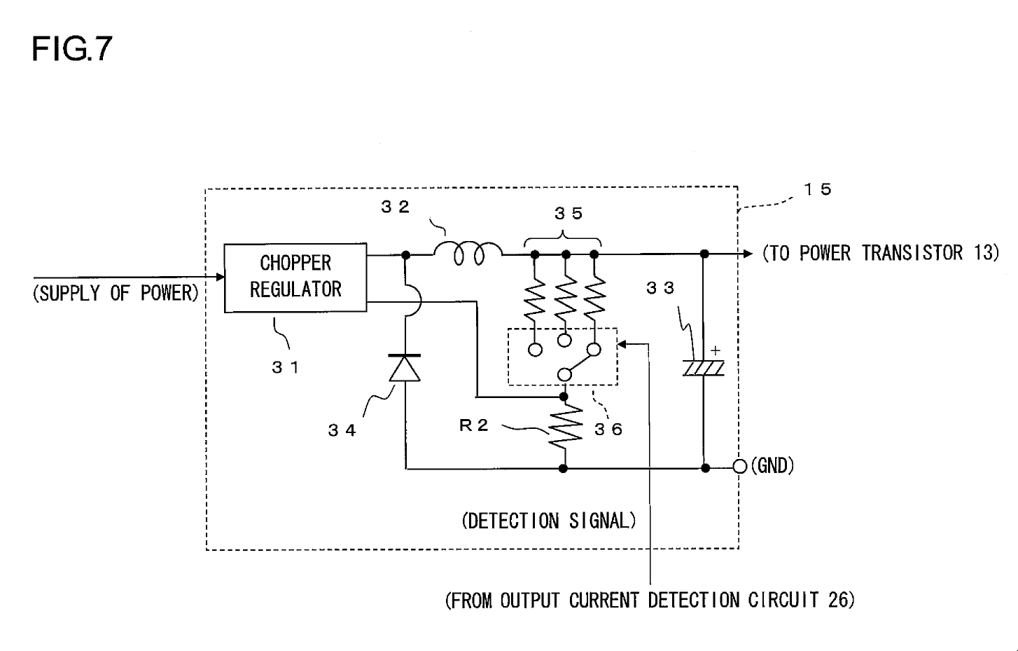

With this configuration, the switching regulator circuit 15 adjusts the supplied power by changing the resistance value of the variable resistor R1 according to the detection signal from the output current detection circuit 26, and then outputs the adjusted power to the power transistor 13. Alternatively, the switching regulator circuit 15 may be configured as shown in FIG. 7.

The switching regulator circuit 15 shown in FIG. 7 includes, in place of the variable resistor R1, a resistor group 35 composed of a plurality of resistors connected in parallel to the output end of the coil 32, the resistors having different resistance values, and a switch 36 that can perform switching between the plurality of resistors for selecting any one of them, and connect the selected resistor to the resistor R2. The switch 36 performs switching according to the detection signal from the output current detection circuit 26. With this configuration, the supplied power is adjusted by changing the type of resistor connected to the resistor R2, and the adjusted power is outputted to the power transistor 13.

Alternatively, the switching regulator circuit 15 may be so configured that the supplied power is adjusted linearly (instead of changing it drastically when a given detection value is detected) in accordance with a detection result (the magnitude of the output current) transmitted from the output current detection circuit 26, and the adjusted power is outputted to the power transistor 13. For example, the switching regulator circuit 15 may be so configured that the detection signal from the output current detection circuit 26 is inputted to the chopper regulator 31, and the chopper regulator 31 is made to linearly change the duty cycle of its output according to the detection signal.

With this configuration, it is possible to supply the power transistor 13 with power at a voltage following variations in the output current with greater accuracy. This makes it easier to minimize power loss in the power transistor 13 regardless of variations in the output current.

### Supplementary Note

As described above, the series regulators described in Examples 1 to 5 each has the power transistor 13 (a power adjusting portion) to which power is supplied, the power transistor 13 adjusting the supplied power (making an adjustment to it) and then outputs the adjusted power to the load, and the comparator 22, the control transistor 21, and the like (an adjustment control portion) that detect an output voltage that is a voltage outputted to the load, and controls the power adjustment based on the detection result thus obtained.

In addition, there are provided a current detecting portion (such as the output current detection circuit 26) that detects the output current that is a current outputted to the load, and a power supplying section (such as the switch circuit 12 or the switching regulator circuit 15) that changes the voltage according to the detection result and supplies power to the power transistor 13 (except for the series regulator described in Example 2, in which the terminal 29 for receiving, from outside, a signal indicating the output current is provided in place of the current detecting portion).

With this configuration, it is possible to change the voltage (input voltage) of power to be supplied to the power transistor 13 according to the output current. As a result, even when the magnitude of the output current varies, it is possible to appropriately adjust the input voltage according to the variations in the output current.

Up to this point the invention has been described, taking up Examples 1 to 5 as examples. The invention may be practiced in any other manner than specifically described above, with any modification or variation made within the spirit of the invention. In addition, all the features of Examples 1 to 5 described above, whenever applicable, can be combined with any other features.

According to the invention, the series regulator described above as an embodiment can change a voltage (input voltage) of power to be supplied to the power adjusting portion according to the output current. This makes it possible to appropriately adjust the input voltage even when the magnitude of the output current varies.

What is claimed is:

1. A series regulator including a power adjusting portion to which power is supplied, the power adjusting portion making an adjustment to the power thus supplied and outputting the power thus adjusted to a load, and an adjustment control portion detecting an output voltage that is a voltage outputted to the load and controlling the adjustment based on a detection result,
the series regulator comprising:
a current detecting portion for detecting an output current that is a current outputted to the load; and
a power supplying section for supplying the power to the power adjusting portion after changing a voltage according to a detection result of the current detecting portion.

2. The series regulator of claim 1,
wherein the power adjusting portion is a transistor connecting between a source of the power and the load with collector and emitter terminals thereof,
wherein the adjustment control portion controls the adjustment by controlling a base current of the transistor based on a result of a comparison of the output voltage and a predetermined reference voltage.

3. The series regulator of claim 1, wherein
the power supplying section comprises:
a switch circuit performing switching between a plurality of power supplies that output power at different voltages for selecting any one of the plurality of power supplies, and connecting the selected power supply to the power adjusting portion; and
a switching control portion for controlling the switching performed by the switch circuit according to the detection result of the current detecting portion.

4. The series regulator of claim 3, wherein
the switching control portion controls the switching according to a result of comparison of the detection result of the current detecting portion and a predetermined threshold value.

5. The series regulator of claim 4, further comprising:
a threshold value setting portion for setting the threshold value in such a way that the threshold value thus set can be changed to any other value.

6. The series regulator of claim 2, wherein
the current detecting portion detects the output current by detecting a temperature of the transistor.

7. The series regulator of claim 1, wherein
the current detecting portion is an overcurrent protection circuit for detecting the output current, and controlling the adjustment in such a way that a detection result is kept below a predetermined value.

8. The series regulator of claim 3, wherein
the switch circuit includes a relay or a semiconductor device.

9. The series regulator of claim 1, wherein
the power supplying section comprises a switching regulator.

10. The series regulator of claim 1, wherein
the power supplying section changes the voltage linearly according to the detection result of the current detecting portion, and supplies the power to the power adjusting portion.

11. The series regulator of claim 1, further comprising:
an output terminal for outputting the detection result of the current detecting portion to an outside.

12. A series regulator including a power adjusting portion to which power is supplied, the power adjusting portion making an adjustment to the power thus supplied and outputting the power thus adjusted to a load, and an adjustment control portion detecting an output voltage that is a voltage outputted to the load and controlling the adjustment based on a detection result,
the series regulator comprising:
a signal input terminal for receiving, from outside, a signal indicating an output current that is a current outputted to the load; and
a power supplying section for supplying power to the power adjusting portion after changing a voltage according to the signal inputted to the signal input terminal.

13. An electronic apparatus, comprising:
the series regulator of any one of claims 1 to 12.
